(19) United States
(12) Patent Application Publication
(10) Pub. No.: US 2019/0384962 A1
(43) Pub. Date: Dec. 19, 2019

(54) METHODS AND SYSTEMS FOR DIAGNOSTIC PLATFORM

(71) Applicant: SCOPIO LABS LTD., Tel Aviv (IL)

(72) Inventors: Itai HAYUT, Tel Aviv (IL); Erez NA'AMAN, Tel Aviv (IL); Eran SMALL, Tei Aviv (IL); Chen BRESTEL, Rehovot (IL)

(21) Appl. No.: 16/338,668

(22) PCT Filed: Oct. 26, 2017
(86) PCT No.: PCT/IB2017/001455

§ 371 Date: Apr. 1, 2019

Related U.S. Application Data
(60) Provisional application No. 62/413,711, filed on Oct. 27, 2016.

(51) Int. Cl. G06K 9/00; G06T 3/40; G06T 7/00; G02B 21/36; G01N 15/14

(52) U.S. Cl. CPC G06K 9/00134; G06T 3/4053; G06T 7/0012; G06K 9/00147; G06K 9/0014; G01N 2015/1006; G01N 15/1475; G06T 2207/10056; G06T 2207/30024; G06T 2207/10152; G06T 2207/20081; G02B 21/367

(57) ABSTRACT

Methods and systems are provided for improved imaging and analyzing of a sample with a large field-of-view at a high image resolution. A diagnostic system may comprise: a microscope comprising a low collection numerical aperture (NA); an imaging device coupled to the microscope; and a processor coupled to the imaging device. The imaging device may be configured to capture a plurality of low-resolution images of a region of a sample viewed by the microscope. The region of the sample may comprise cells. The processor may comprise instructions configured to reconstruct a high-resolution image of the region of the sample using the plurality of low-resolution images. The processor may further comprise instructions configured to analyze a spatial field of the high-resolution image to identify at least one of a cell type or a cell structure of at least one of the cells of the region of the sample.

### CROSS-REFERENCE

This application claims the benefit of U.S. Provisional Patent Application No. 62/413,711, filed Oct. 27, 2016, which application is entirely incorporated herein by reference.

### BACKGROUND

Microscopy is used for many diagnostic applications, such as assessment of white blood cells (WBC) differential, sperm morphology, cervical cancer screening, and more.

Implementation of image-recognition software in order to automate these tests is limited by the ability to create high-resolution digital images over a large field-of-view (e.g., a large viewing area of a sample on a microscope glass slide). Although WSI (whole slide imaging) devices are capable of producing such digital images, they typically rely on high-quality and expensive optics and/or require high-numerical aperture (NA) objective lenses (e.g., an NA of at least 0.75 or more), and usually oil-immersion objective lenses to image cytology and hematology samples. These requirements often dictate a small field of view and small depth-of-field, as well as an oil applicator for oil objectives, which in turn need to be resolved by accurate motors and other expensive components. Performing these diagnostic applications automatically, both in a form of providing a final result or in a form of a decision support system (DSS) that can assist a human expert by pre-classification of cells according to different cell types or quality, is highly desirable.

In light of the above, improved methods and systems may perform cellular analysis with high image resolution over a large field-of-view using a low magnification and oil-free microscopy system.

### SUMMARY

Methods and systems are provided for improved imaging and analyzing of a sample with a high image resolution over a large field-of-view.

In an aspect, disclosed herein is a diagnostic system. The diagnostic system may comprise a microscope comprising a low collection numerical aperture (NA). The diagnostic system may further comprise an imaging device coupled to the microscope. The imaging device may be configured to capture a plurality of low-resolution images of a region of a sample viewed by the microscope. The region of the sample may comprise a plurality of cells. The diagnostic system may further comprise a processor coupled to the imaging device. The processor may comprise instructions configured to reconstruct a high-resolution image of the region of the sample using the plurality of low-resolution images. The reconstructing may be performed non-iteratively. The processor may further comprise instructions configured to analyze a spatial field of the high-resolution image to identify at least one of a cell type or a cell structure of at least one of the plurality of cells of the region of the sample. In some embodiments, the imaging device comprises a plurality of imaging devices. In some embodiments, the plurality of imaging devices comprises a plurality of imaging sensors.

In some embodiments, the processor further comprises instructions to, using the spatial field analysis of the high-resolution image, perform at least one of: screening for cancer or pre-cancerous cells, white blood cells (WBCs) differential count, cytology, cell morphology identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, or gram-stained (positive or negative) bacteria identification.

In some embodiments, the processor further comprises instructions to selectively identify one or more corresponding cell types for the plurality of cells, wherein the one or more corresponding cell types are selected from the group consisting of: neutrophils, lymphocytes, monocytes, eosinophils, and basophils. In some embodiments, the one or more corresponding cell types comprise lymphocytes and monocytes. In some embodiments, the one or more corresponding cell types comprise neutrophils, lymphocytes, monocytes, eosinophils, and basophils.

In some embodiments, the processor further comprises instructions to analyze the spatial field of the high-resolution image for determining a platelet count of the sample. In some embodiments, the microscope is configured to view a sample fixed to a substrate. In some embodiments, the substrate is an optically transparent microscope slide. In some embodiments, the processor further comprises instructions to analyze the spatial field of the high-resolution image for identifying cancer cells. In some embodiments, the cancer cells comprise cervical cancer cells. In some embodiments, the processor further comprises instructions to analyze the spatial field of the high-resolution image for identifying sperm morphology. In some embodiments, the at least one of a cell type or a cell structure comprises at least a cell type or cell structure of urine or fecal matter. In some embodiments, the sample is not stained with one or more staining reagents.

In some embodiments, each of the plurality of low-resolution images is acquired using essentially the same collection numerical aperture (NA). In some embodiments, the region comprises a field-of-view (FOV) comprising a longest dimension of 0.3 mm to 1.5 mm or 0.4 mm to 0.8 mm. In some embodiments, the region comprises a single field-of-view (FOV). In some embodiments, the region comprises a plurality of fields-of-view (FOVs), and wherein the imaging device is configured to capture the plurality of low-resolution images of the plurality of FOVs at one or more locations of the sample. In some embodiments, the processor further comprises instructions configured to allow a user of the system to review each of the at least one of the plurality of cells with an identified cell type or cell structure on an image, the image representing an area of at least 0.5 cm×0.5 cm of the sample. In some embodiments, the one or more locations are determined before identifying the cell type or cell structure of the at least one of the plurality of cells.

In some embodiments, the microscope essentially does not move relative to the sample in a time period between acquisition of the plurality of low-resolution images and reconstruction of the high-resolution image. In some embodiments, the high-resolution image comprises pixels having a pixel size of up to 0.7 μm, up to 0.5 μm, up to 0.3 μm, or up to 0.15 μm. In some embodiments, the high-resolution image comprises a resolution of 1.5 times to 50 times that of the low-resolution image. In some embodiments, the plurality of low-resolution images comprises bright-field microscopy images. In some embodiments, the microscope comprises an objective lens comprising the low collection NA, and wherein the low NA is no more than 0.3, no more than 0.4, no more than 0.5, no more than 0.65, no more than 0.75, or no more than 0.9. In some embodiments, the microscope comprises a dry objective lens. In some embodiments, the microscope comprises an oil immersion free objective lens.

In some embodiments, the imaging device is configured to capture the plurality of low-resolution images using a plurality of different illumination conditions. In some embodiments, the imaging device is configured to capture the plurality of low-resolution images sequentially using the plurality of different illumination conditions. In some embodiments, the plurality of different illumination conditions comprises a plurality of different illumination angles. In some embodiments, the microscope comprises a single light source configured to illuminate the sample at the plurality of different illumination angles. In some embodiments, the microscope comprises a plurality of light sources configured to illuminate the sample at the plurality of different illumination angles. In some embodiments, a relative lateral position between a sample support of the microscope and the sample is configured to remain essentially static while the imaging device captures the plurality of low-resolution images.

In some embodiments, the processor further comprises instructions to apply at least one of image recognition or image segmentation upon the high-resolution image for analyzing the spatial field of the high-resolution image to identify the at least one of a cell type or a cell structure based on sub-cellular features. In some embodiments, the processor further comprises instructions to perform machine learning for analyzing the spatial field of the high-resolution image to identify the at least one of a cell type or a cell structure based on sub-cellular features.

In some embodiments, the processor further comprises instructions to generate an augmented image comprising the high-resolution image, wherein generating the augmented image comprises analysis of the high-resolution image overlaid thereupon. In some embodiments, the analysis comprises the at least one of cell type or cell structure of at least one of the plurality of cells. In some embodiments, the analysis comprises at least one of: screening for cancer or pre-cancerous cells, white blood cells differential count, a CBC test, a platelet count, cytology, cell morphology identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, or gram-stained (positive or negative) bacteria identification.

In another aspect, disclosed herein is a method of cell identification. The method may comprise receiving a plurality of low-resolution images of a region of a sample viewed by a microscope comprising a low collection numerical aperture (NA). The region of the sample may comprise a plurality of cells. The method may further comprise reconstructing a high-resolution image of the region of the sample using the plurality of low-resolution images. The reconstructing may be performed non-iteratively. The method may further comprise identifying at least one of a cell type or a cell structure of at least one of the plurality of cells of the region of the sample, wherein the identifying comprises analyzing a spatial field of the high-resolution image.

In some embodiments, the method may further comprise, performing, using the at least one of a cell type or a cell structure, at least one of: screening for cancer or pre-cancerous cells, white blood cells differential count, a CBC test, a platelet count, cytology, cell morphology identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, or gram-stained (positive or negative) bacteria identification.

In some embodiments, identifying the at least one of a cell type or a cell structure comprises selectively identifying one or more corresponding cell types for the plurality of cells, wherein the one or more corresponding cell types are selected from the group consisting of: neutrophils, lymphocytes, monocytes, eosinophils, and basophils. In some embodiments, wherein the one or more corresponding cell types comprise lymphocytes and monocytes. In some embodiments, the one or more corresponding cell types comprise neutrophils, lymphocytes, monocytes, eosinophils, and basophils.

In some embodiments, the identifying at least one of a cell type or a cell structure comprises determining a platelet count for the region of the sample. In some embodiments, the identifying at least one of a cell type or a cell structure comprises identifying cancer cells. In some embodiments, the cancer cells comprise cervical cancer cells. In some embodiments, the identifying at least one of a cell type or a cell structure comprises determining a sperm morphology. In some embodiments, the identifying at least one of a cell type or a cell structure comprises identifying at least a cell type or cell structure of urine or fecal matter. In some embodiments, the sample is not stained with one or more staining reagents.

In some embodiments, each of the plurality of low-resolution images is acquired using essentially the same collection numerical aperture (NA). In some embodiments, the region comprises a field-of-view (FOV) comprising a longest dimension of 0.3 mm to 1.5 mm or 0.4 mm to 0.8 mm. In some embodiments, the region comprises a single field-of-view (FOV). In some embodiments, the region comprises a plurality of fields-of-view (FOVs), and wherein the imaging device is configured to capture the plurality of low-resolution images of the plurality of FOVs at one or more locations of the sample. In some embodiments, the method further comprises producing for a user's review an image comprising each of the at least one of the plurality of cells with an identified cell type or cell structure, the image representing an area of at least 0.5 cm×0.5 cm of the sample. In some embodiments, the one or more locations are determined before identifying the cell type or cell structure of the at least one of the plurality of cells.

In some embodiments, the microscope essentially does not move relative to the sample in a time period between acquisition of the plurality of low-resolution images and reconstruction of the high-resolution image. In some embodiments, the high-resolution image comprises pixels having a pixel size of up to 0.7 μm, up to 0.5 μm, up to 0.3 μm, or up to 0.15 μm. In some embodiments, the high-resolution image comprises a resolution of 1.5 times to 50 times that of the low-resolution image. In some embodiments, the plurality of low-resolution images comprises bright-field microscopy images. In some embodiments, the microscope comprises an objective lens comprising the low collection NA, and wherein the low NA is no more than 0.3, no more than 0.4, no more than 0.5, no more than 0.65, no more than 0.75, or no more than 0.9. In some embodiments, the microscope comprises a dry objective lens. In some embodiments, the microscope comprises an oil immersion free objective lens.

In some embodiments, identifying at least one of a cell type or a cell structure of at least one of the plurality of cells comprises applying at least one of image recognition or image segmentation to the high-resolution image based on sub-cellular features. In some embodiments, analyzing a spatial field of the high-resolution image comprises applying machine learning techniques to the high-resolution image based on sub-cellular features.

In some embodiments, the method further comprises generating an augmented image comprising the high-resolution image, wherein the augmented image comprises analysis of the high-resolution image overlaid thereupon. In some embodiments, the analysis comprises the at least one of cell type or cell structure of at least one of the plurality of cells.

Additionally, a non-transitory computer-readable storage medium may store program instructions, which are executed by at least one processor and perform any of the methods described herein.

It shall be understood that different aspects of the invention can be appreciated individually, collectively, or in combination with each other. Various aspects of the invention described herein may be applied to any of the particular applications set forth below or for any other types of the congestion control/management system disclosed herein. Any description herein concerning the congestion state measurement may apply to and be used for any other congestion management situations. Additionally, any embodiments disclosed in the context of the congestion movement system are also applicable to the methods disclosed herein.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an diagrammatic representation of an exemplary microscope, in accordance with the disclosed embodiments.

FIG. 2 is an illustration of an exemplary high-resolution image of a sample on a microscope slide, which was reconstructed from a plurality of low-resolution images acquired using bright-field microscopy of a blood sample with a large field-of-view, in accordance with the disclosed embodiments.

FIG. 3 is an illustration of a plurality of exemplary high-resolution images of white blood cells (including neutrophils, lymphocytes, monocytes, eosinophils, and basophils) of a sample on a microscope slide, which was acquired using bright-field microscopy with a large field-of-view, in accordance with the disclosed embodiments.

FIG. 4 is an illustration of an exemplary high-resolution image of a white blood cell of a sample on a microscope slide produced by a diagnostic system, which can be selected by a user of a decision support system (DSS) of the diagnostic system to display a zoomed-out portion of the selected cell's surrounding image, in accordance with the disclosed embodiments.

FIG. 5 is an illustration of an exemplary portion of a high-resolution image of blood cells of a sample on a microscope slide, which was acquired using bright-field microscopy with a large field-of-view, in accordance with the disclosed embodiments.

FIG. 6 shows an illustration of an exemplary portion of a zoomed-out high-resolution image of blood cells of a sample on a microscope slide, which was acquired using bright-field microscopy with a large field-of-view, in accordance with the disclosed embodiments.

FIG. 7 is an exemplary flowchart for a method of cell identification, in accordance with the disclosed embodiments.

FIG. 8 shows a computer control system that is programmed or otherwise configured to implement methods provided herein.

### DETAILED DESCRIPTION OF THE INVENTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Microscopy is used for many diagnostic applications, such as assessment of white blood cells (WBC) differential, sperm morphology, cervical cancer screening, and more. Implementation of image-recognition software in order to automate these tests is limited by the ability to create high-resolution digital images over a large field-of-view (e.g., a large viewing area of a sample on a microscope glass slide). Although WSI (whole slide imaging) devices are capable of producing such digital images, they typically rely on high-quality and expensive optics and/or require high-numerical aperture (NA) objective lenses (e.g., an NA of at least 0.75 or more), and usually oil-immersion objective lenses to image cytology and hematology samples. These requirements often dictate a small field of view and small depth-of-field, as well as an oil applicator for oil objectives, which in turn need to be resolved by accurate motors and other expensive components. Performing these diagnostic applications automatically, both in a form of providing a final result or in a form of a decision support system (DSS) that can assist a human expert by pre-classification of cells according to different cell types or quality, is highly desirable. Moreover, although in many cases microscopy samples are stained with staining reagents, a computational microscopy system may reconstruct high-resolution phase data, and perform these diagnostic applications on both stained and unstained samples. In addition, performing these diagnostic tasks using a large field of view (e.g., by analyzing large-FOV images) may increase the number of cells and structures analyzed and thereby assist in statistical calculations and in identification of rare events with higher performance (e.g., with greater accuracy, sensitivity, and/or specificity).

Automated diagnostic systems (such as flow cytometers) for performing some of these mentioned tests (e.g., CBC) may be limited in their ability to provide accurate results. Further, the results produced by such automated diagnostic systems are often preliminary, and either need to be further interpreted by a human expert using a manual microscope and/or need higher resolution digital images to be acquired using an objective lens with higher NA. Methods and systems are provided to perform diagnostic applications using a low-NA objective lens, such that the image data may be acquired only once and reconstructed images can be further interpreted (e.g., to generate a diagnostic result or a cell classification) automatically or by a human expert without the need for further measurements (e.g., further higher-resolution and/or higher-NA image acquisition) or use of a manual microscope. Such methods and systems may be capable of distinguishing between different cell types, different cell structures, and/or different stages in a cell life cycle (e.g., blasts in blood samples), by incorporating subcellular morphological information (e.g., vacuoles or granular structures) into the image processing. In this context, a general nucleus shape of cells or an existence of (or lack thereof) a nucleus alone is not considered as ‘subcellular’ details that are sufficient for advanced diagnostic applications, such as a 5-part WBC differential, for which smaller cellular details such as vacuoles or cytoplasmic granulation may be needed for accurate differentiation of cell types or cell structures. The low-NA and automated aspects of methods and systems provided may confer advantages such as the possibility of performing these diagnostic tests in a point-of-care setting. This may eliminate the need to physically send a sample to an expert or to a central lab whenever a device raises a “flag” indicating a potential abnormal result and/or the need for the patient to repeat the test at a different location where it can be further interpreted.

Described herein are methods and systems for a diagnostic platform, which can be used for classification, object recognition, WBC differential, pathology decision support system (DSS), other DSS, sperm morphology, cervical cancer screening, and more. Such methods and systems can be used to perform diagnostic applications in a manner such that the specificity and sensitivity of the results using a final high-resolution image generated from a plurality of low-resolution and/or low-intensity images (e.g., processed by combining the phase information of a plurality of low-resolution images) is greater than the specificity and sensitivity of results obtained when performing the same diagnostic application on each of the low-resolution and/or low-intensity images. For example, such methods and systems may be used to perform WBC differential testing with clinical-level performance using an objective lens with low NA (e.g., an NA of no more than 0.3, no more than 0.4, no more than 0.5, no more than 0.65, no more than 0.75, or no more than 0.9). Methods and systems described herein can be combined with other systems such as computational microscopy systems, as is known to one of skill in the art.

In an aspect, disclosed herein is a diagnostic system. The diagnostic system may comprising a microscope comprising a low collection numerical aperture (NA). The diagnostic system may further comprise an imaging device coupled to the microscope. The imaging device may be configured to capture a plurality of low-resolution images of a region of a sample viewed by the microscope. The region of the sample may comprise a plurality of cells. The diagnostic system may further comprise a processor coupled to the imaging device. The processor may comprise instructions configured to generate (e.g., by reconstructing) a high-resolution image of the region of the sample using the plurality of low-resolution images. The diagnostic system may be used to perform a classification (e.g., of a cell type or a cell structure) of the sample based on the generated high-resolution image. For example, the processor may further comprise instructions configured to analyze a spatial field of the high-resolution image to identify at least one of a cell type or a cell structure of at least one of the plurality of cells of the region of the sample. The imaging device may comprise an imaging sensor. The imaging device may comprise a plurality of imaging devices. The plurality of imaging devices may comprise a plurality of imaging sensors. The processor may comprise a plurality of processors. For example, portions of the process may be performed on different computers, e.g., image reconstruction on a local computer and identification of cell types on a cloud server.

As an example, a diagnostic system may comprise a microscope with an objective lens with a low NA (e.g., an NA less than 0.7), and an imaging device coupled to the microscope and configured to acquire a plurality of low-resolution images of a region comprising cells of a blood sample on an optically transparent (e.g., glass) microscope slide which is viewed by the microscope. The diagnostic system may comprise a processor coupled to the imaging device and comprise instructions configured to automatically acquire microscopy images of the sample on the microscopy slide. The processor may further comprise instructions configured to perform a 5-part WBC differential test, a full CBC (Complete Blood Count, including platelets and red blood cells) test, or an automatic 5-part differential test on the acquired microscopy images with clinical-level performance. The low-NA of the microscope may confer several advantages, e.g., the diagnostic system may be configured to automatically perform a clinical-level cell test without user input (e.g., to select a region of interest comprising cells of interest for further scanning, and/or the diagnostic system may be configured to acquire and reconstruct high-resolution microscopy images without using immersion oil. For example, the diagnostic system may be configured to perform an automatic 5-part differential test, from which a final WBC differential count can be calculated, or which can be used as a pre-classification test to present the suggested cell classes for the user to verify or provide a final classification.

As another example, a diagnostic system may comprise an image sensor (optionally with optical element such as an objective lens), a dynamic illumination system capable of illuminating a sample with different illumination conditions at different times, and a processor coupled to the image sensor. The diagnostic system may be configured to acquire a plurality of images of the sample under a plurality of different illumination conditions (e.g., at different illumination angles, different illumination patterns, different wavelengths, or a combination thereof). The diagnostic system may be further configured to reconstruct a higher-resolution image and/or a phase image from the plurality of images acquired under the plurality of different illumination conditions. The diagnostic system may be further configured to analyze the image data in a manner that is more accurate (e.g., with higher sensitivity and/or higher specificity) or convenient (e.g., with automatic diagnostic testing) to the user than is possible with a microscopy system with equivalent-NA objective lens but without dynamic illumination. The diagnostic system may be further configured to process the image data to identify one or more suggested cell types, which are then presented to the user as a decision support system (DSS).

Methods and systems disclosed herein may be used to acquire a plurality of microscopy images and use them to reconstruct an image which has both large field-of-view (FOV) and high resolution (e.g., significantly higher resolution beyond the resolution enabled by the NA of the objective lens). Such methods and systems may confer advantages to diagnostic testing of a sample by obviating a tradeoff between FOV and image resolution (which often translates to a tradeoff between speed and resolution). Previous methods of diagnostic testing using large-FOV, high-resolution images may comprise two separate stages: (1) a first (“prescreening”) stage of acquiring a plurality of low-resolution and large FOV microscopy images (e.g., by using a low-power or low-magnification objective lens) of a region of a sample (e.g., on a glass microscope slide) in order to identify locations of objects of interest (e.g., containing White Blood Cells (WBCs) or other cells of interest) within the sample, but without sufficient resolution to differentiate such objects of interest (e.g., cells) into their specific types (e.g., WBC types); and (2) a second (“final acquisition”) stage of using a high-resolution or high-magnification objective lens to acquire high-resolution microscopy images of the objects of interest (e.g., WBCs) in their locations, as determined in the first stage, in order to perform a final classification to differentiate the objects of interest (e.g., WBCs) into different types.

Such a two-stage process involves a tradeoff between FOV and image resolution (or a tradeoff between speed and image resolution), since the second stage must scan many regions to acquire high-resolution images suitable for diagnostic analysis. Using methods and systems disclosed herein, such a 2-stage process can be obviated, and microscopy images can be acquired using a single magnification and resolution (e.g., using a low-NA objective lens) and further processed to both (1) identify and/or locate objects of interest (e.g., WBCs) and (2) classify the objects of interest (e.g., WBCs) into the different types. High-resolution diagnostic applications, such as hematology, cytology, oncology, sperm morphology, etc., can be performed with lower cost equipment (e.g., low-NA microscopy), with less complexity (a single scanning step), in less time (without the need for pre-screening), and/or with less user input required (e.g., with automatic cell identification). Moreover, although in many cases microscopy samples are stained with staining reagents, a computational microscopy system may reconstruct high-resolution phase data, and perform these diagnostic applications on both stained and unstained samples. In addition, methods and systems disclosed herein may be capable of performing diagnostic tasks using a large field of view (e.g., by analyzing large-FOV images), an approach which may increase the number of cells and structures analyzed and thereby assist in statistical calculations and in identification of rare events with higher performance (e.g., with greater accuracy, sensitivity, and/or specificity).

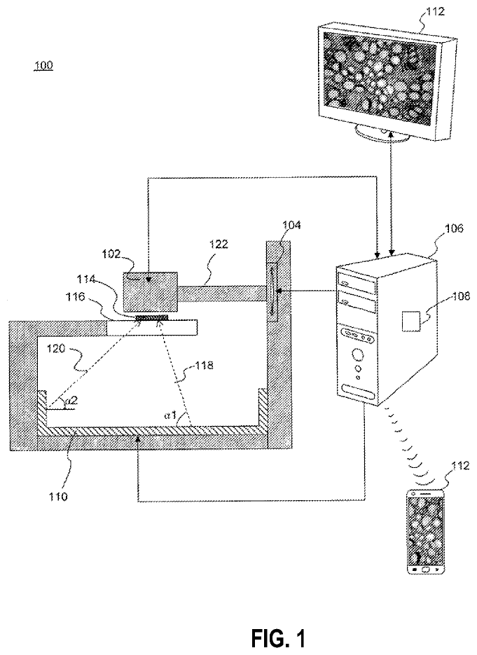

FIG. 1 is a diagrammatic representation of a microscope 100, in accordance with the disclosed embodiments. The term “microscope” refers to any device or instrument for magnifying an object which is smaller than easily observable by the naked eye, e.g., creating an image of an object for a user where the image is larger than the object. One type of microscope may be an “optical microscope” that uses light in combination with an optical system for magnifying an object. An optical microscope may be a simple microscope having one or more magnifying lens. Another type of microscope may be a “computational microscope” that includes an image sensor and image-processing algorithms to enhance or magnify the object's size or other properties. The computational microscope may be a dedicated device or created by incorporating software and/or hardware with an existing optical microscope to produce high-resolution digital images. As shown in FIG. 1, microscope 100 includes an image capture device 102, a focus actuator 104, a controller 106 connected to memory 108, an illumination assembly 110, and a user interface 112. An example usage of microscope 100 may be capturing images of a sample 114 mounted on a stage 116 located within the field-of-view (FOV) of image capture device 102, processing the captured images, and presenting on user interface 112 a magnified image of sample 114.

Image capture device 102 may be used to capture images of sample 114. In this specification, the term “image capture device” includes a device that records the optical signals entering a lens as an image or a sequence of images. The optical signals may be in the near-infrared, infrared, visible, and ultraviolet spectrums. Examples of an image capture device include a CCD camera, a CMOS camera, a photo sensor array, a video camera, a mobile phone equipped with a camera, etc. Some embodiments may include only a single image capture device 102, while other embodiments may include two, three, or even four or more image capture devices 102. In some embodiments, image capture device 102 may be configured to capture images in a defined field-of-view (FOV). Also, when microscope 100 includes several image capture devices 102, image capture devices 102 may have overlap areas in their respective FOVs. Image capture device 102 may have one or more image sensors for capturing image data of sample 114. For example, two sensors may be placed in different focal locations, such that both amplitude and phase can be reconstructed for each illumination condition independently. In other embodiments, image capture device 102 may be configured to capture images at an image resolution higher than 10 Megapixels, higher than 12 Megapixels, higher than 15 Megapixels, or higher than 20 Megapixels. In addition, image capture device 102 may also be configured to have a pixel size up to 10 μm, up to 5 μm, up to 4 μm, up to 3 μm, up to 2 μm, up to 1 μm, up to 0.9 μm, up to 0.8 μm, up to 0.7 μm, up to 0.6 μm, up to 0.5 μm, up to 0.4 μm, up to 0.3 μm, up to 0.2 μm, up to 0.15 μm, up to 0.1 μm, or up to 0.05 μm.

In some embodiments, an image acquired using an objective lens is not more than 50%, not more than 40%, not more than 30%, not more than 20%, not more than 15%, or not more than 10% overlapping with a previous image previously acquired at a different x-y location, or of an area fully contained within an image area previously acquired using an objective lens.

In some embodiments, microscope 100 includes focus actuator 104. The term “focus actuator” refers to any device capable of converting input signals into physical motion for adjusting the relative distance between sample 114 and image capture device 102. Various focus actuators may be used, including, for example, linear motors, electrostrictive actuators, electrostatic motors, capacitive motors, voice coil actuators, magnetostrictive actuators, etc. In some embodiments, focus actuator 104 may include an analog position feedback sensor and/or a digital position feedback element. Focus actuator 104 is configured to receive instructions from controller 106 in order to make light beams converge to form a clear and sharply defined image of sample 114. In the example illustrated in FIG. 1, focus actuator 104 may be configured to adjust the distance by moving image capture device 102. However, in other embodiments, focus actuator 104 may be configured to adjust the distance by moving stage 116, or by moving both image capture device 102 and stage 116.

Microscope 100 may also include controller 106 for controlling the operation of microscope 100 according to the disclosed embodiments. Controller 106 may comprise various types of devices for performing logic operations on one or more inputs of image data and other data according to stored or accessible software instructions providing desired functionality. For example, controller 106 may include a central processing unit (CPU), support circuits, digital signal processors, integrated circuits, cache memory, or any other types of devices for image processing and analysis such as graphic processing units (GPUs). The CPU may comprise any number of microcontrollers or microprocessors configured to process the imagery from the image sensors. For example, the CPU may include any type of single- or multi-core processor, mobile device microcontroller, etc. Various processors may be used, including, for example, processors available from manufacturers such as Intel®, AMD®, etc. and may include various architectures (e.g., x86 processor, ARM®, etc.). The support circuits may be any number of circuits generally well known in the art, including cache, power supply, clock and input-output circuits.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106. Specifically, memory 108 may refer to multiple structures or computer-readable storage mediums located at controller 106 or at a remote location, such as a cloud server. Memory 108 may comprise any number of random access memories, read only memories, flash memories, disk drives, optical storage, tape storage, removable storage and other types of storage.

Microscope 100 may include illumination assembly 110. The term “illumination assembly” refers to any device or system capable of projecting light to illuminate sample 114. Illumination assembly 110 may include any number of light sources, such as light emitting diodes (LEDs), lasers, and lamps configured to emit light. In one embodiment, illumination assembly 110 may include only a single light source. Alternatively, illumination assembly 110 may include four, sixteen, or even more than a hundred light sources organized in an array or a matrix. In some embodiments, illumination assembly 110 may use one or more light sources located at a surface parallel to illuminate sample 114. In other embodiments, illumination assembly 110 may use one or more light sources located at a surface perpendicular or at an angle to sample 114. In addition, illumination assembly 110 may be configured to illuminate sample 114 in a series of different illumination conditions. In one example, illumination assembly 110 may include a plurality of light sources arranged in different illumination angles, such as a two-dimensional arrangement of light sources. In this case, the different illumination conditions may include different illumination angles. For example, FIG. 1 depicts a beam 118 projected from a first illumination angle α1, and a beam 120 projected from a second illumination angle α2. As another example, illumination assembly 110 may include a plurality of light sources configured to emit light in different wavelengths. In this case, the different illumination conditions may include different wavelengths. In yet another example, illumination assembly 110 may configured to use a number of light sources at predetermined times. In this case, the different illumination conditions may include different illumination patterns. Accordingly and consistent with the present disclosure, the different illumination conditions may be selected from a group including: different durations, different intensities, different positions, different illumination angles, different illumination patterns, different wavelengths, or any combination thereof.

Consistent with disclosed embodiments, microscope 100 may include, be connected with, or in communication with (e.g., over a network or wirelessly, e.g., via Bluetooth) user interface 112. The term “user interface” refers to any device suitable for presenting a magnified image of sample 114 or any device suitable for receiving inputs from one or more users of microscope 100. FIG. 1 illustrates two examples of user interface 112. The first example is a smartphone or a tablet wirelessly communicating with controller 106 over a Bluetooth, cellular connection or a Wi-Fi connection, directly or through a remote server. The second example is a PC display physically connected to controller 106. In some embodiments, user interface 112 may include user output devices, including, for example, a display, tactile device, speaker, etc. In other embodiments, user interface 112 may include user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

Microscope 100 may also include or be connected to stage 116. Stage 116 includes any horizontal rigid surface where sample 114 may be mounted for examination. Stage 116 may include a mechanical connector for retaining a slide containing sample 114 in a fixed position. The mechanical connector may use one or more of the following: a mount, an attaching member, a holding arm, a clamp, a clip, an adjustable frame, a locking mechanism, a spring or any combination thereof. In some embodiments, stage 116 may include a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

In some embodiments, the microscope 100 is configured to view a sample 114 fixed to a substrate. For example, the substrate may be an optically transparent microscope slide (e.g., a glass slide). In some embodiments, the plurality of low-resolution images comprises bright-field microscopy images. The microscope 100 may comprise an objective lens with a low NA of no more than 0.3, no more than 0.4, no more than 0.5, no more than 0.65, no more than 0.75, or no more than 0.9. The microscope may comprise a dry objective lens. For example, the microscope may comprise an oil immersion free objective lens.

The microscope 100 and imaging device may be configured to capture a region of the sample. Such a region may comprise, for example, a blood smear or other sample on a microscope slide. A blood smear may be obtained, for example, by obtaining a blood sample via finger prick or venipuncture of a subject, and smearing and drying the blood sample onto the microscope slide. Alternatively, a region comprising cells may be obtained by processing a blood sample or other sample from a subject and arranging the processed cells of the sample onto a microscope slide (e.g., by cytocentrifugation). The region may comprise a field-of-view (FOV) comprising a longest dimension of, for example, 0.3 mm to 1.5 mm or 0.4 mm to 0.8 mm. In certain configurations, the region may comprise an FOV comprising a longest dimension of up to 1 mm, up to 5 mm, up to 10 mm, up to 15 mm, up to 20 mm, up to 25 mm, up to 30 mm, up to 35 mm, up to 40 mm, up to 45 mm, up to 50 mm, up to 55 mm, up to 60 mm, up to 65 mm, up to 70 mm, up to 75 mm, or more than 75 mm. In some configurations, the region may comprise an FOV comprising a longest dimension within a range of 0.3 mm to 1 mm, 1.5 mm to 5 mm, 1.5 mm to 10 mm, 1.5 mm to 15 mm, 1.5 mm to 20 mm, 1.5 mm to 25 mm, 5 mm to 10 mm, 10 mm to 15 mm, 15 mm to 20 mm, 20 mm to 25 mm, 25 mm to 30 mm, 30 mm to 35 mm, 35 mm to 40 mm, 40 mm to 45 mm, 45 mm to 50 mm, 50 mm to 55 mm, 55 mm to 60 mm, 60 mm to 65 mm, 65 mm to 70 mm, or 70 mm to 75 mm.

The region may comprise an FOV comprising a transverse dimension shorter than the longest dimension, wherein the transverse dimension is perpendicular to the longest dimension. The region may comprise an FOV comprising a transverse dimension of, for example, 0.3 mm to 1.5 mm or 0.4 mm to 0.8 mm. In certain configurations, the region may comprise an FOV comprising a transverse dimension of up to 1 mm, up to 5 mm, up to 10 mm, up to 15 mm, up to 20 mm, up to 25 mm, up to 30 mm, up to 35 mm, up to 40 mm, up to 45 mm, up to 50 mm, up to 55 mm, up to 60 mm, up to 65 mm, up to 70 mm, up to 75 mm, or more than 75 mm. In some configurations, the region may comprise an FOV comprising a transverse dimension within a range of 0.3 mm to 1 mm, 1.5 mm to 5 mm, 1.5 mm to 10 mm, 1.5 mm to 15 mm, 1.5 mm to 20 mm, 1.5 mm to 25 mm, 5 mm to 10 mm, 10 mm to 15 mm, 15 mm to 20 mm, 20 mm to 25 mm, 25 mm to 30 mm, 30 mm to 35 mm, 35 mm to 40 mm, 40 mm to 45 mm, 45 mm to 50 mm, 50 mm to 55 mm, 55 mm to 60 mm, 60 mm to 65 mm, 65 mm to 70 mm, or 70 mm to 75 mm.

The region may comprise an FOV comprising an area of, for example, about 0.1 mm², about 0.2 mm², about 0.3 mm², about 0.4 mm², about 0.5 mm², about 0.6 mm², about 0.7 mm², about 0.8 mm², about 0.9 mm², about 1 mm², about 2 mm², about 3 mm², about 4 mm², about 5 mm², about 6 mm², about 7 mm², about 8 mm², about 9 mm², about 10 mm², about 20 mm², about 30 mm², about 40 mm², about 50 mm², about 60 mm², about 70 mm², about 80 mm², about 90 mm², about 100 mm², about 125 mm², about 150 mm², about 175 mm², about 200 mm², or more than 200 mm². The region may comprise an FOV comprising an area within a range of 0.1 mm² to 0.5 mm², 0.5 mm² to 1 mm², 0.5 mm² to 5 mm², 0.5 mm² to 10 mm², 0.5 mm² to 15 mm², 1 mm² to 5 mm², 5 mm² to 10 mm², 10 mm² to 20 mm², 20 mm² to 30 mm², 30 mm² to 40 mm², 40 mm² to 50 mm², 50 mm² to 60 mm², 60 mm² to 70 mm², 70 mm² to 80 mm², 80 mm² to 90 mm², 90 mm² to 100 mm², 100 mm² to 125 mm², 125 mm² to 150 mm², 150 mm² to 175 mm², or 175 mm² to 200 mm².

The region may comprise a single field-of-view (FOV). Alternatively, the region may comprise a plurality of fields-of-view (FOVs), and the imaging device may be configured to capture the plurality of low-resolution images of the plurality of FOVs at one or more locations of the sample. For example, such an approach may be used to increase the resolution and FOV of the high-resolution image by scanning together multiple FOVs, stitching together the multiple FOVs, and generating a large total FOV with high resolution.

In some embodiments, a relative lateral position between a sample support of the microscope 100 and the sample 114 may be configured to remain essentially static while the imaging device captures the plurality of low-resolution images. This can be achieved, for example, by using essentially the same collection numerical aperture (NA) to acquire each of the plurality of low-resolution images. In some embodiments, the microscope essentially does not move relative to the sample in a time period between acquisition of the plurality of low-resolution images and reconstruction of the high-resolution image. Similarly, this can be achieved, for example, by using essentially the same collection numerical aperture (NA) to acquire each of the plurality of low-resolution images. The high-resolution image may comprise pixels having a pixel size of about 10 μm, about 5 μm, about 4 μm, about 3 μm, about 2 μm, about 1 μm, about 0.9 μm, about 0.8 μm, about 0.7 μm, about 0.6 μm, about 0.5 μm, about 0.4 μm, about 0.3 μm, about 0.2 μm, about 0.15 μm, about 0.1 μm, or about 0.05 μm. The high-resolution image may comprise pixels having a pixel size in a range of 0.05 μm to 0.1 μm, 0.1 μm to 0.15 μm, 0.15 μm to 0.2 μm, 0.2 μm to 0.3 μm, 0.3 μm to 0.4 μm, 0.4 μm to 0.5 μm, 0.5 μm to 0.6 μm, 0.6 μm to 0.7 μm, 0.7 μm to 0.8 μm, 0.8 μm to 0.9 μm, 0.9 μm to 1 μm, 1 μm to 2 μm, 2 μm to 3 μm, 3 μm to 4 μm, 4 μm to 5 μm, or 5 μm to 10 μm. The high-resolution image may comprise a resolution of about 1.5 times, about 2 times, about 3 times, about 4 times, about 5 times, about 6 times, about 7 times, about 8 times, about 9 times, about 10 times, about 15 times, about 20 times, about 25 times, about 30 times, about 35 times, about 40 times, about 45 times, about 50 times, about 60 times, about 70 times, about 80 times, about 90 times, about 100 times, or more than 100 times that of the low-resolution image. For example, the high-resolution image may comprise a resolution of 1.5 times to 50 times that of the low-resolution image.

In some embodiments, the imaging device (image capture device 102) is configured to capture the plurality of low-resolution images using a plurality of different illumination conditions. For example, the imaging device (image capture device 102) may be configured to capture the plurality of low-resolution images sequentially using the plurality of different illumination conditions. The plurality of different illumination conditions may comprise a plurality of different illumination angles. The microscope 100 may comprise a single light source configured to illuminate the sample at the plurality of different illumination angles. Alternatively, the microscope 100 may comprise a plurality of light sources configured to illuminate the sample at the plurality of different illumination angles. Such images captured under different illumination conditions may be used to reconstruct a high-resolution and large-FOV image of a sample (e.g., as described in International Application No. PCT/IB2016/001725, published as International Pub. No. WO 2017/081542 A2, which is hereby incorporated by reference in its entirety). Such high-resolution and large-FOV images generated from a plurality of low-resolution images may feature greater detail and image resolution than would be otherwise possible by either image acquisition using the NA of the objective lens or the resolution of the image sensor or by using multi-spectral imaging or methods of increasing effective sensor pixel count (e.g., pixel super-resolution methods).

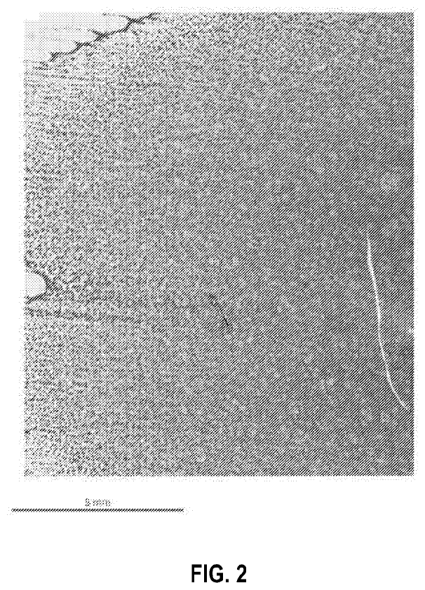

FIG. 2 is an illustration of an exemplary high-resolution image of a sample on a microscope slide, which was reconstructed from a plurality of low-resolution images acquired using bright-field microscopy of a blood sample with a large field-of-view, in accordance with the disclosed embodiments. There are several known methods in the field of computational imaging processing for producing a high-resolution image of a sample from a plurality of low-resolution images. A high-resolution image may be generated (e.g., reconstructed) from a set of low-resolution images taken with different illumination conditions, but does not require an iterative process, thereby decreasing the computation time needed to reconstruct the high-resolution image (e.g., as described in International Application No. PCT/IB2016/001725, published as International Pub. No. WO 2017/081542 A2). Another method to generate high-resolution image from a plurality of low-resolution images is, for example, ptychography. These methods may use an iterative process in order to compute the high-resolution image in a way that the reconstructed image in each iteration is compared to a pre-iteration high-resolution image, and the difference between them serves as the convergence condition.

Controller 106 may acquire images at a first image resolution and generate a reconstructed image of sample 114 having a second (enhanced) image resolution. The term “image resolution” is a measure of the degree to which the image represents the fine details of sample 114. For example, the quality of a digital image may also be related to the number of pixels and the range of brightness values available for each pixel. In some embodiments, generating the reconstructed image of sample 114 is based on images having an image resolution lower than the enhanced image resolution. The enhanced image resolution may have at least 2 times, 5 times, 10 times, or 100 times more pixels than the lower image resolution images. For example, the first image resolution of the captured images may be referred to hereinafter as low-resolution and may have a value between 1 megapixel and 25 megapixels, between 10 megapixels and 20 megapixels, or about 15 megapixels. Whereas, the second image resolution of the reconstructed image may be referred to hereinafter as high-resolution and may have a value higher than 10 megapixels, higher than 50 megapixels, higher than 100 megapixels, higher than 500 megapixels, or higher than 1000 megapixels.

In some embodiments, the processor of the diagnostic system further comprises instructions to apply at least one of image recognition or image segmentation upon the high-resolution image for analyzing the spatial field of the high-resolution image to identify the at least one of a cell type or a cell structure based on sub-cellular features. Image recognition or image segmentation of the high-resolution image may be performed using any known image processing or pattern recognition method. For example, image segmentation methods may include thresholding, edge detection, region detection, or statistical classification algorithms. For example, the processor may comprise instructions to perform machine learning, deep learning, supervised learning, unsupervised learning, or other image recognition or pattern recognition algorithms for analyzing the spatial field of the high-resolution image, e.g., to identify the at least one of a cell type or a cell structure based on sub-cellular features. Such methods may comprise extracting a plurality of sub-cellular features and/or sub-cellular structures for use as input data for the image recognition, image segmentation, machine learning, or other image recognition or pattern recognition algorithm for analyzing the spatial field of the high-resolution image. Examples of sub-cellular features may include hypersegmentation of cell nuclei and structure of cell vacuoles. Sub-cellular features may comprise dimensions of about 10 μm, about 5 μm, about 4 μm, about 3 μm, about 2 μm, about 1 μm, about 0.9 μm, about 0.8 μm, about 0.7 μm about 0.6 μm, about 0.5 μm, about 0.4 μm, about 0.3 μm, about 0.2 μm, or about 0.1 μm. Sub-cellular features may comprise dimensions in a range of 0.1 μm to 0.2 μm, 0.2 μm to 0.3 μm, 0.3 μm to 0.4 μm, 0.4 μm to 0.5 μm, 0.5 μm to 0.6 μm, 0.6 μm to 0.7 μm, 0.7 μm to 0.8 μm, 0.8 μm to 0.9 μm, 0.9 μm to 1 μm, 1 μm to 2 μm, 2 μm to 3 μm, 3 μm to 4 μm, 4 μm to 5 μm, 5 μm to 10 μm, or more than 10 μm. Examples of machine learning algorithms may include support vector machines (SVMs), neural networks, convolutional neural networks (CNNs), k-Nearest Neighbor (k-NN) classification, and random forests (RFs). Identifying the at least one of a cell type or a cell structure based on sub-cellular features may comprise classifying the objects of interest (e.g., putative cells) detected from the high-resolution image into one of a plurality of classes or categories (e.g., WBC types, cancerous or non-cancerous cells, healthy or abnormal sperm cells, etc.).

After the spatial field analysis of the high-resolution image is performed, the processor may further comprise instructions to, using the spatial field analysis of the high-resolution image, perform one or more of a variety of diagnostic tests, such as screening for cancer or pre-cancerous cells, white blood cells differential count, a CBC test, a platelet count, cytology, or cell morphology (e.g., sperm morphology) identification. The at least one of a cell type or a cell structure may comprise at least a cell type or cell structure of urine or fecal matter. The sample may be stained with one or more staining reagents. Alternatively, the sample may not be stained with one or more staining reagents. The processor may further comprise instructions to selectively identify one or more corresponding cell types for the plurality of cells. For example, the one or more corresponding cell types may comprise at least one of, at least two of, at least three of, at least four of, or all five of: neutrophils, lymphocytes, monocytes, eosinophils, and basophils. For example, the one or more corresponding cell types may comprise lymphocytes and monocytes.

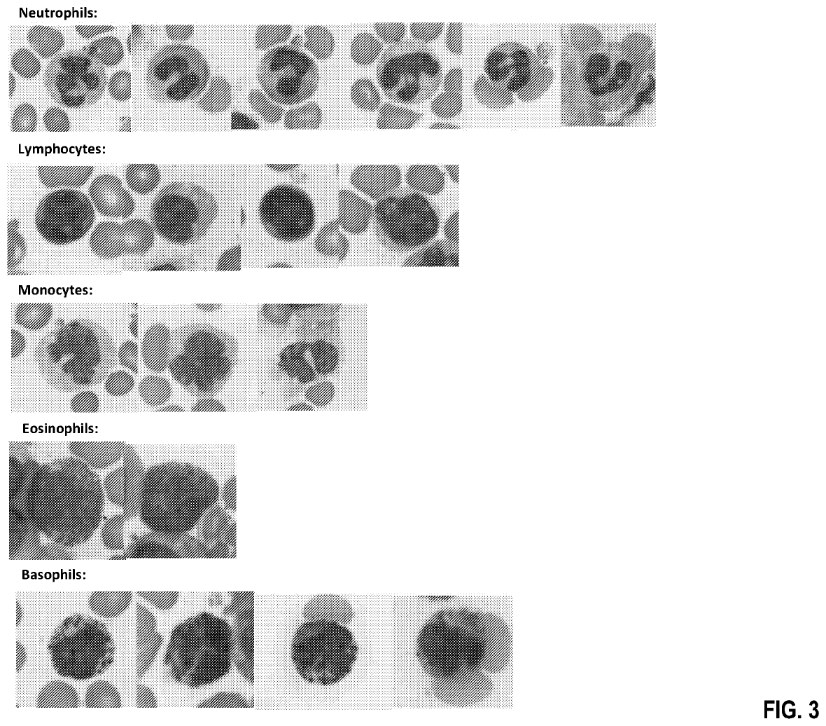

FIG. 3 is an illustration of a plurality of exemplary high-resolution images of white blood cells (including neutrophils, lymphocytes, monocytes, eosinophils, and basophils) of a blood sample on a microscope slide, which was acquired using bright-field microscopy with a large field-of-view, in accordance with the disclosed embodiments. In this example, each of five different types of white blood cells can be automatically identified by spatial field analysis of a single high-resolution, large-FOV image of a blood sample on a microscope slide. Notably, the same set of images (i.e., the plurality of low-resolution images) is used for both identification of WBCs as well as differentiation of the WBCs into different types (e.g., neutrophils, lymphocytes, monocytes, eosinophils, and basophils).

In some embodiments, the processor further comprises instructions configured to allow a user of the system to review each of the at least one of the plurality of cells with an identified cell type or cell structure on an image. For example, the image may represent an area of at least 0.5 cm×0.5 cm of the sample. The one or more locations may be determined before identifying the cell type or cell structure of the at least one of the plurality of cells. For example, the one or more locations may be selected by a user of the system.

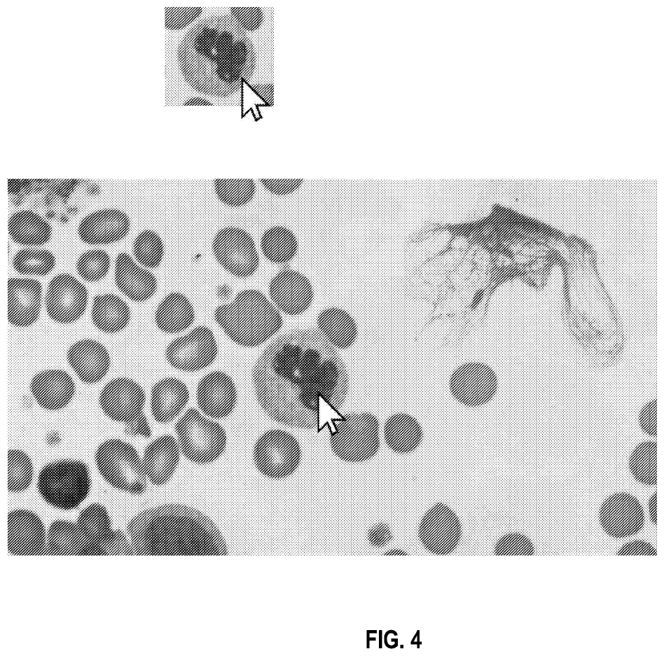

FIG. 4 is an illustration of an exemplary high-resolution image of a white blood cell of a sample on a microscope slide produced by a diagnostic system, which can be selected by a user of a decision support system (DSS) of the diagnostic system to display a zoomed-out portion of the selected cell's surrounding image, in accordance with the disclosed embodiments. The DSS can display a classification gallery which displays a plurality of identified cells in such a manner to assist a user of the system (e.g., a human expert such as a pathologist or other clinician) by pre-classification of cells according to different cell types or quality (e.g., organized by cell sub-type such as WBC type or cell stage) for the user's approval and validation. The DSS can display zoomed-out portions of selected cell(s) surrounding image(s) in order to provide more cell context to assist with, for example, a final determination of cell count or assessment of cell type or quality. For example, the DSS can be configured in a manner such that, when the images of pre-classified cells are presented to the user, the user can choose (e.g., by pressing the image icon of a graphical user interface (GUI) of the DSS) to ‘jump’ from viewing the cell in the classification gallery into viewing the specific cell location on the large scanned slide in high resolution, which is comprised of an area significantly larger (e.g., about 2×, about 3×, about 4×, about 5×, about 6×, about 7×, about 8×, about 9×, about 10×, about 100×, about 500×, about 1000×, or more than 1000×) than the image presented in the classification gallery.

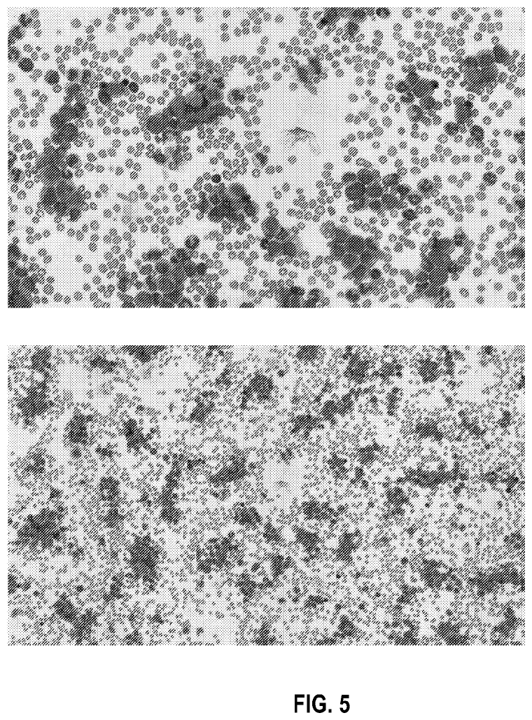

FIG. 5 is an illustration of an exemplary portion of a high-resolution image of blood cells of a sample on a microscope slide, which was acquired using bright-field microscopy with a large field-of-view, in accordance with the disclosed embodiments.

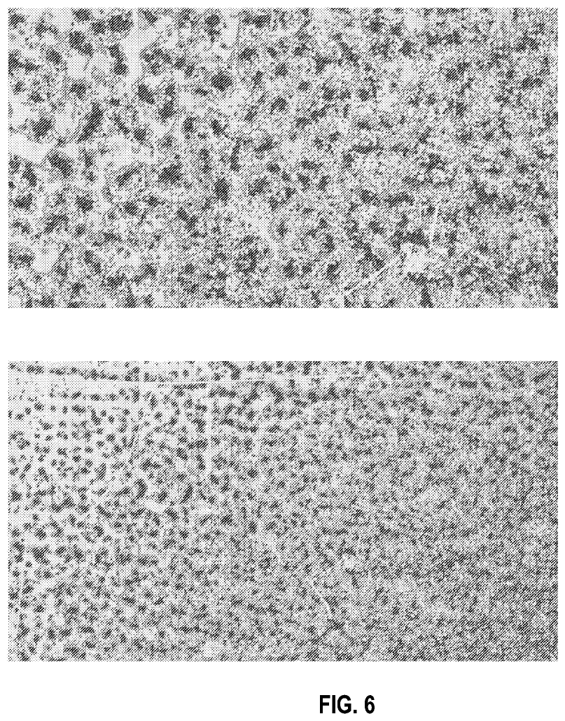

FIG. 6 shows an illustration of an exemplary portion of a zoomed-out high-resolution image of blood cells of a sample on a microscope slide, which was acquired using bright-field microscopy with a large field-of-view, in accordance with the disclosed embodiments.

In some embodiments, the processor further comprises instructions to generate an augmented image comprising the high-resolution image. The generation of the augmented image may comprise analysis of the high-resolution image overlaid thereupon. The analysis may comprise the at least one of cell type or cell structure of at least one of the plurality of cells. The analysis may comprise at least one of: screening for cancer or pre-cancerous cells, white blood cells differential count, a CBC test, a platelet count, cytology, cell morphology (e.g., sperm morphology) identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, gram-stained (positive or negative) bacteria identification, and the like.

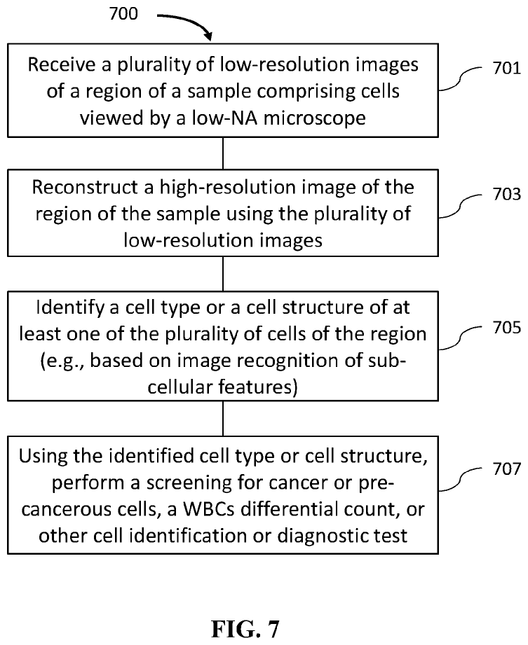

FIG. 7 is an exemplary flowchart for a method of cell identification, in accordance with the disclosed embodiments. In one aspect, disclosed herein is a method of cell identification 700. The method of cell identification may comprise, in step 701, receiving a plurality of low-resolution images of a region of a sample viewed by a microscope comprising a low collection numerical aperture (NA), wherein the region of the sample comprises a plurality of cells. The method of cell identification may further comprise, in step 703, reconstructing a high-resolution image of the region of the sample using the plurality of low-resolution images. The method of cell identification may further comprise, in step 705, identifying at least one of a cell type or a cell structure of at least one of the plurality of cells of the region of the sample. The identifying may comprise analyzing a spatial field of the high-resolution image.

The method of cell identification may further comprise, in step 707, performing, using the at least one of a cell type or a cell structure, at least one of: screening for cancer or pre-cancerous cells, white blood cells differential count, cytology, or cell morphology identification. The identifying the at least one of a cell type or a cell structure may comprise selectively identifying one or more corresponding cell types for the plurality of cells. For example, the one or more corresponding cell types may comprise at least one of, at least two of, at least three of, at least four of, or all five of: neutrophils, lymphocytes, monocytes, eosinophils, and basophils. For example, the one or more corresponding cell types may comprise lymphocytes and monocytes. The identifying at least one of a cell type or a cell structure may comprise determining a platelet count for the region of the sample. The identifying at least one of a cell type or a cell structure may comprise identifying a cervical cancer cell. The identifying at least one of a cell type or a cell structure may comprise determining a sperm morphology. The identifying at least one of a cell type or a cell structure may comprise identifying at least a cell type or cell structure of urine or fecal matter. The sample may be stained with one or more staining reagents. Alternatively, the sample may not be stained with one or more staining reagents.

In some embodiments, the low NA is no more than 0.3, no more than 0.4, no more than 0.5, no more than 0.65, no more than 0.75, or no more than 0.9. The microscope may comprise a dry objective lens. For example, the microscope may comprise an oil immersion free objective lens.

The microscope and imaging device may be configured to capture a region of the sample. Such a region may comprise, for example, a blood smear or other sample on a microscope slide. A blood smear may be obtained, for example, by obtaining a blood sample via finger prick or venipuncture of a subject, and smearing and drying the blood sample onto the microscope slide. Alternatively, a region comprising cells may be obtained by processing a blood sample or other sample from a subject and arranging the processed cells of the sample onto a microscope slide (e.g., by cytocentrifugation). The region may comprise a field-of-view (FOV) comprising a longest dimension of, for example, 0.3 mm to 1.5 mm or 0.4 mm to 0.8 mm. In certain configurations, the region may comprise a FOV comprising a longest dimension of up to 1 mm, up to 5 mm, up to 10 mm, up to 15 mm, up to 20 mm, up to 25 mm, up to 30 mm, up to 35 mm, up to 40 mm, up to 45 mm, up to 50 mm, up to 55 mm, up to 60 mm, up to 65 mm, up to 70 mm, up to 75 mm, or more than 75 mm. In some configurations, the region may comprise an FOV comprising a longest dimension within a range of 0.3 mm to 1 mm, 1.5 mm to 5 mm, 1.5 mm to 10 mm, 1.5 mm to 15 mm, 1.5 mm to 20 mm, 1.5 mm to 25 mm, 5 mm to 10 mm, 10 mm to 15 mm, 15 mm to 20 mm, 20 mm to 25 mm, 25 mm to 30 mm, 30 mm to 35 mm, 35 mm to 40 mm, 40 mm to 45 mm, 45 mm to 50 mm, 50 mm to 55 mm, 55 mm to 60 mm, 60 mm to 65 mm, 65 mm to 70 mm, or 70 mm to 75 mm.

The region may comprise an FOV comprising a transverse dimension shorter than the longest dimension, wherein the transverse dimension is perpendicular to the longest dimension. The region may comprise an FOV comprising a transverse dimension of, for example, 0.3 mm to 1.5 mm or 0.4 mm to 0.8 mm. In certain configurations, the region may comprise an FOV comprising a transverse dimension of up to 1 mm, up to 5 mm, up to 10 mm, up to 15 mm, up to 20 mm, up to 25 mm, up to 30 mm, up to 35 mm, up to 40 mm, up to 45 mm, up to 50 mm, up to 55 mm, up to 60 mm, up to 65 mm, up to 70 mm, up to 75 mm, or more than 75 mm. In some configurations, the region may comprise an FOV comprising a transverse dimension within a range of 0.3 mm to 1 mm, 1.5 mm to 5 mm, 1.5 mm to 10 mm, 1.5 mm to 15 mm, 1.5 mm to 20 mm, 1.5 mm to 25 mm, 5 mm to 10 mm, 10 mm to 15 mm, 15 mm to 20 mm, 20 mm to 25 mm, 25 mm to 30 mm, 30 mm to 35 mm, 35 mm to 40 mm, 40 mm to 45 mm, 45 mm to 50 mm, 50 mm to 55 mm, 55 mm to 60 mm, 60 mm to 65 mm, 65 mm to 70 mm, or 70 mm to 75 mm.

The region may comprise an FOV comprising an area of, for example, about 0.1 mm², about 0.2 mm², about 0.3 mm², about 0.4 mm², about 0.5 mm², about 0.6 mm², about 0.7 mm², about 0.8 mm², about 0.9 mm², about 1 mm², about 2 mm², about 3 mm², about 4 mm², about 5 mm², about 6 mm², about 7 mm², about 8 mm², about 9 mm², about 10 mm², about 20 mm², about 30 mm², about 40 mm², about 50 mm², about 60 mm², about 70 mm², about 80 mm², about 90 mm², about 100 mm², about 125 mm², about 150 mm², about 175 mm², about 200 mm², or more than 200 mm². The region may comprise an FOV comprising an area within a range of 0.1 mm² to 0.5 mm², 0.5 mm² to 1 mm², 0.5 mm² to 5 mm², 0.5 mm² to 10 mm², 0.5 mm² to 15 mm², 1 mm² to 5 mm², 5 mm² to 10 mm², 10 mm² to 20 mm², 20 mm² to 30 mm², 30 mm² to 40 mm², 40 mm² to 50 mm², 50 mm² to 60 mm², 60 mm² to 70 mm², 70 mm² to 80 mm², 80 mm² to 90 mm², 90 mm² to 100 mm², 100 mm² to 125 mm², 125 mm² to 150 mm², 150 mm² to 175 mm², or 175 mm² to 200 mm²

The region may comprise a single field-of-view (FOV). Alternatively, the region may comprise a plurality of fields-of-view (FOVs), and the imaging device may be configured to capture the plurality of low-resolution images of the plurality of FOVs at one or more locations of the sample. For example, such an approach may be used to increase the resolution and FOV of the high-resolution image by scanning together multiple FOVs, stitching together the multiple FOVs, and generating a large total FOV with high resolution.

In some embodiments, a relative lateral position between a sample support of the microscope and the sample may be configured to remain essentially static while the imaging device captures the plurality of low-resolution images. This can be achieved, for example, by using essentially the same collection numerical aperture (NA) to acquire each of the plurality of low-resolution images. In some embodiments, the microscope essentially does not move relative to the sample in a time period between acquisition of the plurality of low-resolution images and reconstruction of the high-resolution image. Similarly, this can be achieved, for example, by using essentially the same collection numerical aperture (NA) to acquire each of the plurality of low-resolution images. The high-resolution image may comprise pixels having a pixel size of about 10 μm, about 5 μm, about 4 μm, about 3 μm, about 2 μm, about 1 μm, about 0.9 μm, about 0.8 μm, about 0.7 μm, about 0.6 μm, about 0.5 μm, about 0.4 μm, about 0.3 μm, about 0.2 μm, about 0.15 μm, about 0.1 μm, or about 0.05 μm. The high-resolution image may comprise pixels having a pixel size in a range of 0.05 μm to 0.1 μm, 0.1 μm to 0.15 μm, 0.15 μm to 0.2 μm, 0.2 μm to 0.3 μm, 0.3 μm to 0.4 μm, 0.4 μm to 0.5 μm, 0.5 μm to 0.6 μm, 0.6 μm to 0.7 μm, 0.7 μm to 0.8 μm, 0.8 μm to 0.9 μm, 0.9 μm to 1 μm, 1 μm to 2 μm, 2 μm to 3 μm, 3 μm to 4 μm, 4 μm to 5 μm, or 5 μm to 10 μm. The high-resolution image may comprise a resolution of about 1.5 times, about 2 times, about 3 times, about 4 times, about 5 times, about 6 times, about 7 times, about 8 times, about 9 times, about 10 times, about 15 times, about 20 times, about 25 times, about 30 times, about 35 times, about 40 times, about 45 times, about 50 times, about 60 times, about 70 times, about 80 times, about 90 times, about 100 times, or more than 100 times that of the low-resolution image. For example, the high-resolution image may comprise a resolution of 1.5 times to 50 times that of the low-resolution image.

The identifying the at least one of a cell type or a cell structure may comprise applying at least one of image recognition or image segmentation to the high-resolution image based on sub-cellular features. The identifying of at least one of a cell type or a cell structure may comprise applying machine learning techniques to the high-resolution image based on sub-cellular features. Image recognition or image segmentation of the high-resolution image may be performed using any known image processing or pattern recognition method. For example, image segmentation methods may include thresholding, edge detection, region detection, statistical classification algorithms, or machine learning. For example, the identifying of at least one of a cell type or a cell structure may comprise performing machine learning, deep learning, supervised learning, unsupervised learning, or other image recognition or pattern recognition algorithms for analyzing the spatial field of the high-resolution image based on sub-cellular features. Such methods may comprise extracting a plurality of sub-cellular features and/or sub-cellular structures for use as input data for the image recognition, image segmentation, machine learning, or other image recognition or pattern recognition algorithm for analyzing the spatial field of the high-resolution image. Examples of sub-cellular features may include hyperpigmentation of cell nuclei and structure of cell vacuoles. Sub-cellular features may comprise dimensions of about 10 μm, about 5 μm, about 4 μm, about 3 μm, about 2 μm, about 1 μm, about 0.9 μm, about 0.8 μm, about 0.7 μm, about 0.6 μm, about 0.5 μm, about 0.4 μm, about 0.3 μm, about 0.2 μm, or about 0.1 μm. Sub-cellular features may comprise dimensions in a range of 0.1 μm to 0.2 μm, 0.2 μm to 0.3 μm, 0.3 μm to 0.4 μm, 0.4 μm to 0.5 μm, 0.5 μm to 0.6 μm, 0.6 μm to 0.7 μm, 0.7 μm to 0.8 μm, 0.8 μm to 0.9 μm, 0.9 μm to 1 μm, 1 μm to 2 μm, 2 μm to 3 μm, 3 μm to 4 μm, 4 μm to 5 μm, 5 μm to 10 μm, or more than 10 μm. Examples of machine learning algorithms may include support vector machines (SVMs), neural networks, convolutional neural networks (CNNs), k-Nearest Neighbor (k-NN) classification, and random forests (RFs). Identifying the at least one of a cell type or a cell structure based on sub-cellular features may comprise classifying the objects of interest (e.g., putative cells) detected from the high-resolution image into one of a plurality of classes or categories (e.g., WBC types, cancerous or non-cancerous cells, healthy or abnormal sperm cells, etc.).

The method of cell identification may further comprise generating an augmented image comprising the high-resolution image. Generating the augmented image may comprise analysis of the high-resolution image overlaid thereupon. The analysis may comprise the at least one of cell type or cell structure of at least one of the plurality of cells.

### Computer Control Systems

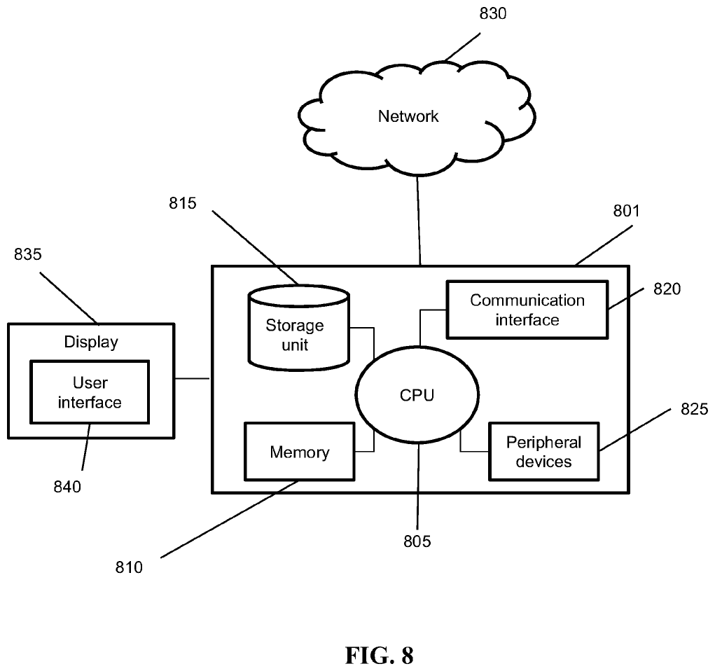

The present disclosure provides computer control systems that are programmed to implement methods of the disclosure. FIG. 8 shows a computer system 801 that is programmed or otherwise configured to: receive a plurality of low-resolution images of a region of a sample viewed by a microscope, reconstruct a high-resolution image of the region of the sample using the plurality of low-resolution images, and/or identify at least one of a cell type or a cell structure of at least one of the plurality of cells of the region of the sample by analyzing a spatial field of the high-resolution image.

The computer system 801 can regulate various aspects of methods and systems of the present disclosure, such as, for example, receiving a plurality of low-resolution images of a region of a sample viewed by a microscope, reconstructing a high-resolution image of the region of the sample using the plurality of low-resolution images, and/or identifying at least one of a cell type or a cell structure of at least one of the plurality of cells of the region of the sample by analyzing a spatial field of the high-resolution image.

The computer system 801 can be an electronic device of a user or a computer system that is remotely located with respect to the electronic device. The electronic device can be a mobile electronic device. The computer system 801 includes a central processing unit (CPU, also “processor” and “computer processor” herein) 805, which can be a single core or multi core processor, or a plurality of processors for parallel processing. The computer system 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The computer system 801 can be operatively coupled to a computer network (“network”) 830 with the aid of the communication interface 820. The network 830 can be the Internet, an internet and/or extranet, or an intranet and/or extranet that is in communication with the Internet.

The network 830 in some cases is a telecommunication and/or data network. The network 830 can include one or more computer servers, which can enable distributed computing, such as cloud computing. For example, one or more computer servers may enable cloud computing over the network 830 (“the cloud”) to perform various aspects of analysis, calculation, and generation of the present disclosure, such as, for example, receiving a plurality of low-resolution images of a region of a sample viewed by a microscope, reconstructing a high-resolution image of the region of the sample using the plurality of low-resolution images, and/or identifying at least one of a cell type or a cell structure of at least one of the plurality of cells of the region of the sample by analyzing a spatial field of the high-resolution image. Another example can be receiving an already reconstructed high-resolution image of the region of the sample, and/or identifying at least one of a cell type or a cell structure of at least one of the plurality of cells of the region of the sample by analyzing a spatial field of the high-resolution image. Such cloud computing may be provided by cloud computing platforms such as, for example, Amazon Web Services (AWS), Microsoft Azure, Google Cloud Platform, and IBM cloud. The network 830, in some cases with the aid of the computer system 801, can implement a peer-to-peer network, which may enable devices coupled to the computer system 801 to behave as a client or a server. ‘Cloud’ services (including with one or more of the cloud platforms mentioned above) may also be used to provide data storage.

The CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. In some cases, the circuit is an application specific integrated circuit (ASIC). The CPU 805 may comprise one or more general purpose processors, one or more graphics processing units (GPUs), or a combination thereof.

The storage unit 815 can store files, such as drivers, libraries and saved programs. The storage unit 815 can store user data, e.g., user preferences and user programs, and/or store low-resolution and high-resolution image files (sometimes exchanging data with the memory). The computer system 801 in some cases can include one or more additional data storage units that are external to the computer system 801, such as located on a remote server that is in communication with the computer system 801 through an intranet or the Internet.

The computer system 801 can communicate with one or more remote computer systems through the network 830. For instance, the computer system 801 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 801 via the network 830. The user may control or regulate various aspects of methods and systems of the present disclosure, such as, for example, receiving a plurality of low-resolution images of a region of a sample viewed by a microscope, reconstructing a high-resolution image of the region of the sample using the plurality of low-resolution images, identifying at least one of a cell type or a cell structure of at least one of the plurality of cells of the region of the sample by analyzing a spatial field of the high-resolution image, and/or selecting one or more cells for further review and/or classification.

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software. During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory, Solid-state memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, user selection of algorithms, image data, and databases. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 805. The algorithm can, for example, receive a plurality of low-resolution images of a region of a sample viewed by a microscope, reconstruct a high-resolution image of the region of the sample using the plurality of low-resolution images (possibly in a non-iterative manner), identify at least one of a cell type or a cell structure of at least one of the plurality of cells of the region of the sample by analyzing a spatial field of the high-resolution image, apply image recognition or image segmentation upon the high-resolution image, and/or perform machine learning for analyzing the spatial field of the high-resolution image.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A diagnostic system comprising:
a microscope comprising a low collection numerical aperture (NA);
an imaging device coupled to the microscope, wherein the imaging device is configured to capture a plurality of low-resolution images of a region of a sample viewed by the microscope, wherein the region of the sample comprises a plurality of cells; and
a processor coupled to the imaging device, the processor comprising instructions configured to:
reconstruct a high-resolution image of the region of the sample using the plurality of low-resolution images; and
analyze a spatial field of the high-resolution image to identify at least one of a cell type or a cell structure of at least one of the plurality of cells of the region of the sample.

2. The system of claim 1, wherein the imaging device comprises a plurality of imaging devices.

3. The system of claim 2, wherein the plurality of imaging devices comprises a plurality of imaging sensors.

4. The system of claim 1, wherein the processor comprises a plurality of processors.

5. The system of claim 1, wherein the reconstructing is performed non-iteratively.

6. The system of claim 1, wherein the processor further comprises instructions to, using the spatial field analysis of the high-resolution image, perform at least one of: screening for cancer or pre-cancerous cells, white blood cells (WBCs) differential count, cytology, cell morphology identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, or gram-stained (positive or negative) bacteria identification.

7. The system of claim 1, wherein the processor further comprises instructions to selectively identify one or more corresponding cell types for the plurality of cells, wherein the one or more corresponding cell types are selected from the group consisting of: neutrophils, lymphocytes, monocytes, eosinophils, and basophils.

8. The system of claim 7, wherein the one or more corresponding cell types comprise lymphocytes and monocytes.

9. The system of claim 7, wherein the one or more corresponding cell types comprise neutrophils, lymphocytes, monocytes, eosinophils, and basophils.

10. The system of claim 1, wherein the processor further comprises instructions to analyze the spatial field of the high-resolution image for determining a platelet count of the sample.

11. The system of claim 1, wherein the microscope is configured to view a sample fixed to a substrate.

12. The system of claim 11, wherein the substrate is an optically transparent microscope slide.

13. The system of claim 1, wherein the processor further comprises instructions to analyze the spatial field of the high-resolution image for identifying cancer cells.

14. The system of claim 13, wherein the cancer cells comprise cervical cancer cells.

15. The system of claim 1, wherein the processor further comprises instructions to analyze the spatial field of the high-resolution image for identifying sperm morphology.

16. The system of claim 1, wherein the at least one of a cell type or a cell structure comprises at least a cell type or cell structure of urine or fecal matter.

17. The system of claim 1, wherein the sample is not stained with one or more staining reagents.

18. The system of claim 7, wherein each of the plurality of low-resolution images is acquired using essentially the same collection numerical aperture (NA).

19. The system of claim 1, wherein the region comprises a field-of-view (FOV) comprising a longest dimension of 0.3 mm to 1.5 mm or 0.4 mm to 0.8 mm.

20. The system of claim 1, wherein the region comprises a single field-of-view (FOV).

21. The system of claim 1, wherein the region comprises a plurality of fields-of-view (FOVs), and wherein the imaging device is configured to capture the plurality of low-resolution images of the plurality of FOVs at one or more locations of the sample.

22. The system of claim 21, wherein the processor further comprises instructions configured to allow a user of the system to review each of the at least one of the plurality of cells with an identified cell type or cell structure on an image, the image representing an area of at least 0.5 cm×0.5 cm of the sample.

23. The system of claim 21, wherein the one or more locations are determined before identifying the cell type or cell structure of the at least one of the plurality of cells.

24. The system of claim 1, wherein the microscope essentially does not move relative to the sample in a time period between acquisition of the plurality of low-resolution images and reconstruction of the high-resolution image.

25. The system of claim 1, wherein the high-resolution image comprises pixels having a pixel size of up to 0.7 μm, up to 0.5 μm, up to 0.3 μm, or up to 0.15 μm.

26. The system of claim 1, wherein the high-resolution image comprises a resolution of 1.5 times to 50 times that of the low-resolution image.

27. The system of claim 1, wherein the plurality of low-resolution images comprises bright-field microscopy images.

28. The system of claim 1, wherein the microscope comprises an objective lens comprising the low collection NA, and wherein the low NA is no more than 0.3, no more than 0.4, no more than 0.5, no more than 0.65, no more than 0.75, or no more than 0.9.

29. The system of claim 1, wherein the microscope comprises a dry objective lens.

30. The system of claim 29, wherein the microscope comprises an oil immersion free objective lens.

31. The system of claim 1, wherein the imaging device is configured to capture the plurality of low-resolution images using a plurality of different illumination conditions.

32. The system of claim 31, wherein the imaging device is configured to capture the plurality of low-resolution images sequentially using the plurality of different illumination conditions.

33. The system of claim 31, wherein the plurality of different illumination conditions comprises a plurality of different illumination angles.

34. The system of claim 33, wherein the microscope comprises a single light source configured to illuminate the sample at the plurality of different illumination angles.

35. The system of claim 33, wherein the microscope comprises a plurality of light sources configured to illuminate the sample at the plurality of different illumination angles.

36. The system of claim 1, wherein a relative lateral position between a sample support of the microscope and the sample is configured to remain essentially static while the imaging device captures the plurality of low-resolution images.

37. The system of claim 1, wherein the processor further comprises instructions to apply at least one of image recognition or image segmentation upon the high-resolution image for analyzing the spatial field of the high-resolution image to identify the at least one of a cell type or a cell structure based on sub-cellular features.

38. The system of claim 1, wherein the processor further comprises instructions to perform machine learning for analyzing the spatial field of the high-resolution image to identify the at least one of a cell type or a cell structure based on sub-cellular features.

39. The system of claim 1, wherein the processor further comprises instructions to generate an augmented image comprising the high-resolution image, wherein generating the augmented image comprises analysis of the high-resolution image overlaid thereupon.

40. The system of claim 39, wherein the analysis comprises the at least one of cell type or cell structure of at least one of the plurality of cells.

41. The system of claim 39, wherein the analysis comprises at least one of: screening for cancer or pre-cancerous cells, white blood cells differential count, a CBC test, a platelet count, cytology, cell morphology identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, or gram-stained (positive or negative) bacteria identification.

42. A method of cell identification, comprising:
receiving a plurality of low-resolution images of a region of a sample viewed by a microscope comprising a low collection numerical aperture (NA), wherein the region of the sample comprises a plurality of cells;
reconstructing a high-resolution image of the region of the sample using the plurality of low-resolution images; and
identifying at least one of a cell type or a cell structure of at least one of the plurality of cells of the region of the sample, wherein the identifying comprises analyzing a spatial field of the high-resolution image.

43. The method of claim 42, wherein the reconstructing is performed non-iteratively.

44. The method of claim 42, further comprising, performing, using the at least one of a cell type or a cell structure, at least one of: screening for cancer or pre-cancerous cells, white blood cells differential count, a CBC test, a platelet count, cytology, cell morphology identification, blasts (specific immature WBCs) identification, nucleated red blood cells identification, Auer rods identification, Dohle bodies identification, Mitotic figures (cells) identification, Chromosome abnormalities (Karyotype) screening, Tuberculosis infection detection, or gram-stained (positive or negative) bacteria identification.

45. The method of claim 42, wherein identifying the at least one of a cell type or a cell structure comprises selectively identifying one or more corresponding cell types for the plurality of cells, wherein the one or more corresponding cell types are selected from the group consisting of: neutrophils, lymphocytes, monocytes, eosinophils, and basophils.

46. The method of claim 45, wherein the one or more corresponding cell types comprise lymphocytes and monocytes.

47. The method of claim 45, wherein the one or more corresponding cell types comprise neutrophils, lymphocytes, monocytes, eosinophils, and basophils.

48. The method of claim 42, wherein the identifying at least one of a cell type or a cell structure comprises determining a platelet count for the region of the sample.

49. The method of claim 42, wherein the identifying at least one of a cell type or a cell structure comprises identifying cancer cells.

50. The method of claim 49, wherein the cancer cells comprise cervical cancer cells.

51. The method of claim 42, wherein the identifying at least one of a cell type or a cell structure comprises determining a sperm morphology.

52. The method of claim 42, wherein the identifying at least one of a cell type or a cell structure comprises identifying at least a cell type or cell structure of urine or fecal matter.

53. The system of claim 42, wherein the sample is not stained with one or more staining reagents.

54. The method of claim 42, wherein each of the plurality of low-resolution images is acquired using essentially the same collection numerical aperture (NA).

55. The method of claim 42, wherein the region comprises a field-of-view (FOV) comprising a longest dimension of 0.3 mm to 1.5 mm or 0.4 mm to 0.8 mm.

56. The method of claim 42, wherein the region comprises a single field-of-view (FOV).

57. The method of claim 42, wherein the region comprises a plurality of fields-of-view (FOVs), and wherein the imaging device is configured to capture the plurality of low-resolution images of the plurality of FOVs at one or more locations of the sample.

58. The method of claim 57, further comprising producing for a user's review an image comprising each of the at least one of the plurality of cells with an identified cell type or cell structure, the image representing an area of at least 0.5 cm×0.5 cm of the sample.

59. The method of claim 57, wherein the one or more locations are determined before identifying the cell type or cell structure of the at least one of the plurality of cells.

60. The method of claim 42, wherein the microscope essentially does not move relative to the sample in a time period between acquisition of the plurality of low-resolution images and reconstruction of the high-resolution image.

61. The method of claim 42, wherein the high-resolution image comprises pixels having a pixel size of up to 0.7 μm, up to 0.5 μm, up to 0.3 μm, or up to 0.15 μm.

62. The method of claim 42, wherein the high-resolution image comprises a resolution of 1.5 times to 50 times that of the low-resolution image.

63. The method of claim 42, wherein the plurality of low-resolution images comprises bright-field microscopy images.

64. The method of claim 42, wherein the microscope comprises an objective lens comprising the low collection NA, and wherein the low NA is no more than 0.3, no more than 0.4, no more than 0.5, no more than 0.65, no more than 0.75, or no more than 0.9.

65. The method of claim 42, wherein the microscope comprises a dry objective lens.

66. The method of claim 65, wherein the microscope comprises an oil immersion free objective lens.

67. The method of claim 42, wherein identifying at least one of a cell type or a cell structure of at least one of the plurality of cells comprises applying at least one of image recognition or image segmentation to the high-resolution image based on sub-cellular features.

68. The method of claim 42, wherein analyzing a spatial field of the high-resolution image comprises applying machine learning techniques to the high-resolution image based on sub-cellular features.

69. The method of claim 42, further comprising generating an augmented image comprising the high-resolution image, wherein the augmented image comprises analysis of the high-resolution image overlaid thereupon.

70. The method of claim 69, wherein the analysis comprises the at least one of cell type or cell structure of at least one of the plurality of cells.
